(19) United States
(12) Patent Application Publication
(10) Pub. No.: US 2022/0155255 A1
(43) Pub. Date: May 19, 2022

(54) ELECTROPHORESIS APPARATUS

(71) Applicant: SHIMADZU CORPORATION, Kyoto-shi, Kyoto (JP)

(72) Inventors: Hiroyuki MATSUMOTO, Kyoto-shi, Kyoto (JP); Koki MIYAZAKI, Kyoto-shi, Kyoto (JP)

(73) Assignee: SHIMADZU CORPORATION, Kyoto-shi, Kyoto (JP)

(21) Appl. No.: 17/439,461

(22) PCT Filed: Mar. 19, 2019
(86) PCT No.: PCT/JP2019/011398

§ 371 Date: Sep. 15, 2021

(51) Int. Cl. G01N 27/447

(52) U.S. Cl. CPC G01N 27/44743; G01N 27/4473; G01N 27/44791

(57) ABSTRACT

An electrophoresis apparatus includes: a sample plate including a sample receptacle; a protective sheet; a rack that supports the sample plate; a cover mounted on the protective sheet; a rack receiving mechanism that receives the rack; a punch pin; a dispensing probe; and a chip holder, and the rack receiving mechanism includes: a rack holder that removably holds the rack; and an urging portion that urges the cover toward the sample plate while the rack is held by the rack holder.

### TECHNICAL FIELD

The present invention relates to an electrophoresis apparatus.

### BACKGROUND ART

For example, Japanese Patent Laying-Open No. 2018-004557 (hereinafter referred to as “PTL 1”) discloses an electrophoresis apparatus including a well plate, a protective sheet, a dispensing probe, a pre-punch pin, and a chip holder. The well plate has a plurality of receptacles, and each of the receptacles contains a sample (DNA, protein, or the like). The well plate is supported by a rack placed on a base plane. The protective sheet is adhered to a surface of the well plate to cover each of the receptacles and thereby prevent evaporation of the sample contained in the receptacles. The dispensing probe is used, for example, to suck or dispense the sample contained in the well plate. The pre-punch pin is used to open a hole in the protective sheet, before the dispensing probe sucks the sample in the well plate. The chip holder is placed on the base plane. The chip holder holds a microchip having a separation channel for separating the sample by electrophoresis.

### CITATION LIST

### Patent Literature

PTL 1: Japanese Patent Laying-Open No. 2018-004557

### SUMMARY OF INVENTION

### Technical Problem

For the electrophoresis apparatus as disclosed in PTL 1, it is desirable to shorten the time taken between analyses. For example, in the electrophoresis apparatus disclosed in PTL 1, if the rack supporting the well plate (hereinafter referred to as “sample plate”) cannot be removed, the sample plate cannot be replaced during cleaning of the channel of the microchip, for example, resulting in a longer time taken to start the next analysis.

Moreover, in the electrophoresis apparatus disclosed in PTL 1, as the number of times the pre-punch pin opens a hole in the protective sheet increases, it is more likely that an adhesive on the protective sheet sticks to the tip of the pre-punch pin. If the adhesive sticking to the tip of the pre-punch pin is brought into contact with the sample plate and the pre-punch pin is moved up, the sample plate is lifted away from the rack, together with the ascending pre-punch pin, which may cause the sample in the sample plate to scatter.

An object of the present invention is to provide an electrophoresis apparatus that enables the time taken between analyses to be shortened and also enables the sample plate to be prevented from being lifted away during analysis.

### Solution to Problem

A first aspect of the present invention relates to an electrophoresis apparatus including: a sample plate including a sample receptacle for containing a sample to be analyzed; a protective sheet bonded to a surface of the sample plate and covering the sample receptacle; a rack that supports the sample plate; a cover mounted on the protective sheet; a rack receiving mechanism that receives the rack; a punch pin that opens a hole in the protective sheet; a dispensing probe that sucks and dispenses the sampled contained in the receptacle; and a chip holder that holds a microchip having a separation channel for separating the sample by electrophoresis, and the rack receiving mechanism includes: a rack holder that removably holds the rack; and an urging portion that urges the cover toward the sample plate while the rack is held by the rack holder.

### Advantageous Effects of Invention

The electrophoresis apparatus includes the rack holder that removably holds the rack supporting the sample plate, and therefore, the rack can be removed from the rack holder to simultaneously perform preparation of a sample plate to be used for the next analysis, and cleaning, for example, of the separation channel of the microchip. Accordingly, the time taken between analyses can be shortened. Further, in the electrophoresis apparatus, the urging portion urges the cover toward the sample plate while the rack is held by the rack holder, and therefore, even when an adhesive of the protective sheet sticks to the punch pin, the sample plate is prevented from being lifted away during analysis.

### BRIEF DESCRIPTION OF DRAWINGS

FIG. 1 is a perspective view schematically showing a configuration of an electrophoresis apparatus in one embodiment of the present invention.

FIG. 2 is a perspective view of a sample unit of the electrophoresis apparatus shown in FIG. 1.

FIG. 3 is an exploded perspective view of the sample unit.

FIG. 4 is a perspective view showing a state before the sample unit is received in a rack receiving mechanism.

FIG. 5 is a perspective view shoeing a state in which the sample unit is received in the rack receiving mechanism.

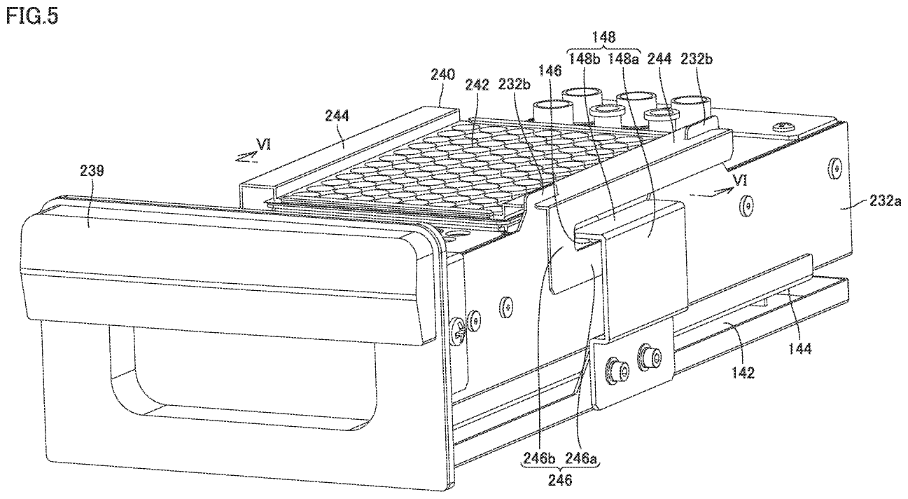

FIG. 6 is a cross-sectional view along a line VI-VI in FIG. 5.

### DESCRIPTION OF EMBODIMENTS

Embodiments of the present invention are described with reference to the drawings. In the drawings referenced below, the same or corresponding parts are denoted by the same reference numerals.

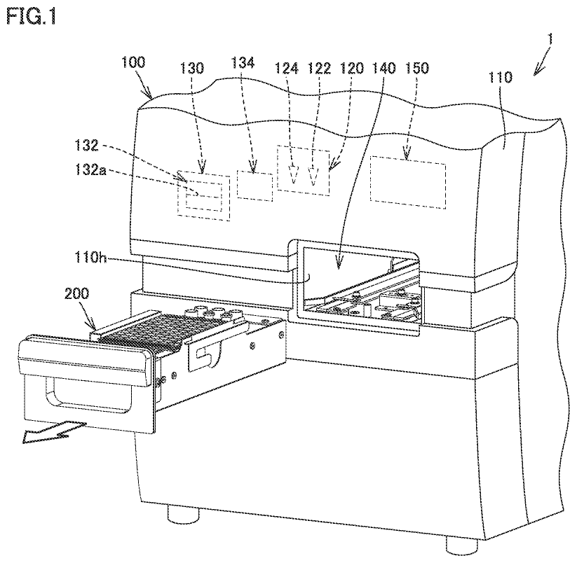

FIG. 1 schematically shows a configuration of an electrophoresis apparatus in one embodiment of the present invention. As shown in FIG. 1, electrophoresis apparatus 1 includes an apparatus body 100 and a sample unit 200.

In apparatus body 100, a sample (DNA, RNA, protein or the like) is analyzed. Apparatus body 100 includes a housing 110, a dispensing probe portion 120, a chip holder 130, a voltage applicator 134, a rack receiving mechanism 140, and a controller 150.

Housing 110 accommodates dispensing probe portion 120, chip holder 130, voltage applicator 134, rack receiving mechanism 140, and controller 150, for example. Housing 110 has an insertion opening 110h for allowing sample unit 200 to be inserted through the insertion opening.

Dispensing probe portion 120 dispenses a sample and supplies a cleaning liquid, for example. Dispensing probe portion 120 includes a dispensing probe 122 and a punch pin 124.

Dispensing probe 122 is used to suck and dispense a sample, and dispense a cleaning liquid, for example. Dispensing probe 122 is supported by a probe support (not shown).

Punch pin 124 opens a hole in a protective sheet 220 which is described later herein. Punch pin 124 is supported by the probe support (not shown).

Chip holder 130 holds a microchip 132. Chip holder 130 is fixed within housing 110. Microchip 132 includes a separation channel 132a for separating a sample by electrophoresis.

Voltage applicator 134 applies a voltage to microchip 132. Accordingly, the sample is separated through separation channel 132a.

Rack receiving mechanism 140 receives sample unit 200. Rack receiving mechanism 140 is described later herein.

Controller 150 controls dispensing probe portion 120 and voltage applicator 134, for example. Controller 150 is implemented, for example, by a so-called microcomputer in which a CPU (Central Processing Unit) and a memory for example are mounted. Controller 150 is connected to a computer provided externally to electrophoresis apparatus 1.

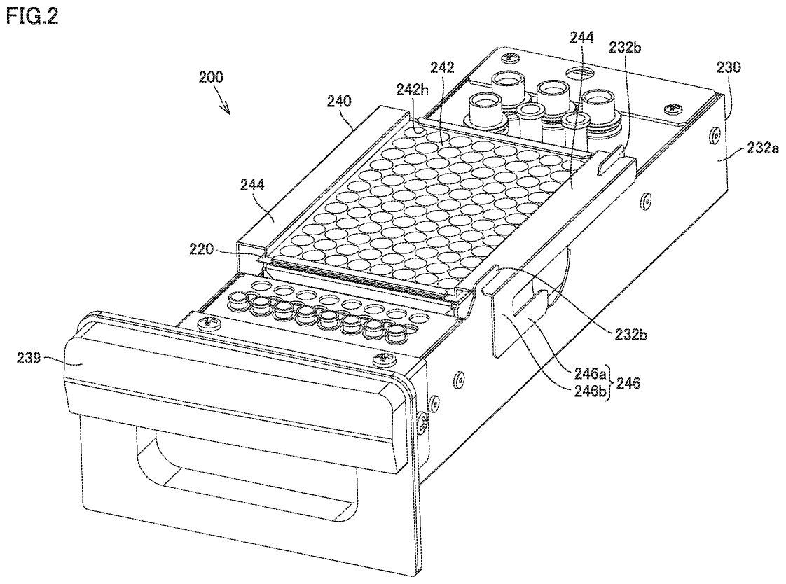

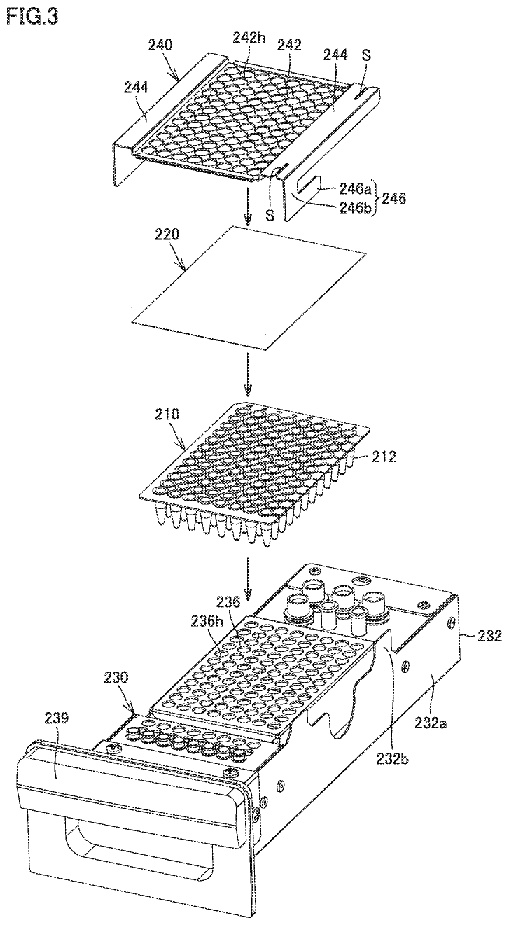

Sample unit 200 is a unit that holds a sample and is attached to and detached from apparatus body 100. As shown in FIGS. 2 and 3, sample unit 200 includes a sample plate 210, a protective sheet 220, a rack 230, and a cover 240.

Sample plate 210 includes a plurality of (96 in the present embodiment) receptacles 212. Each receptacle 212 contains a sample to be analyzed.

Protective sheet 220 is bonded to a surface of sample plate 210 so that the protective sheet covers receptacles 212. Protective sheet 220 has a function of preventing evaporation of the sample contained in receptacles 212.

Rack 230 supports sample plate 210. Rack 230 includes a rack body 232, a plate support 236, and a handle 239.

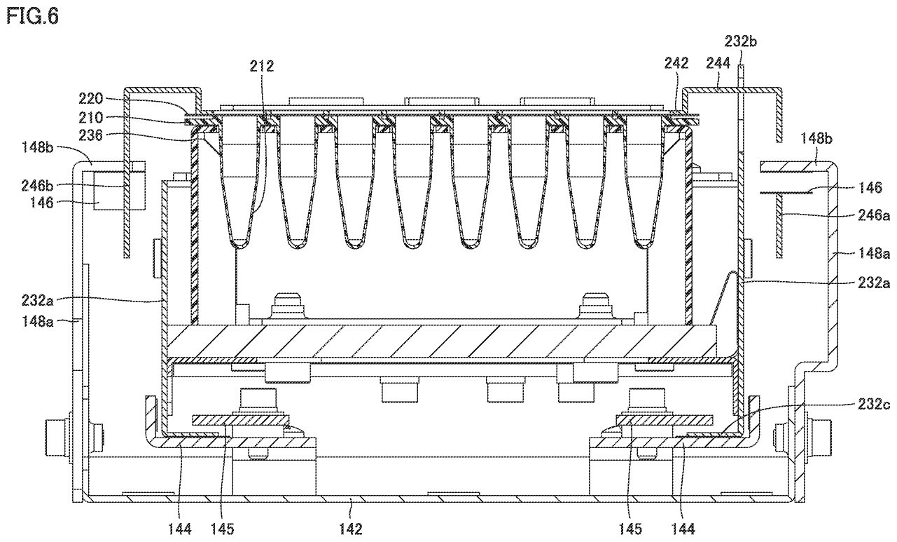

Rack body 232 is received in rack receiving mechanism 140 of apparatus body 100. Rack body 232 includes a pair of sidewalls 232a, a pair of positioning protrusions 232b, and a guided portion 232c (see FIG. 6).

Sidewalls 232a face each other. Each sidewall 232a is formed in a flat plate shape. Each sidewall 232a is shaped longer in a single direction (the direction of insertion into rack receiving mechanism 140).

Each positioning protrusion 232b is shaped to protrude upward from the upper end of one of sidewalls 232a. Each positioning protrusion 232b is formed in a flat plate shape. Each positioning protrusion 232b is located at a position separated in a single direction from the other positioning protrusion 232b. One of the positioning protrusions 232b may not be provided.

Guided portion 232c is connected to the lower end of each sidewall 232a. Guided portion 232c is shaped to protrude inward in the width direction (the direction in which the pair of sidewalls 232a face each other) from the lower end of each sidewall 232a, and extends in a single direction.

Plate support 236 supports sample plate 210. Plate support 236 is fixed between the pair of sidewalls 232a of rack body 232. Plate support 236 has openings 236h in which respective receptacles 212 are to be inserted.

Handle 239 is a part to be gripped by a user to move rack body 232 in a single direction. Handle 239 is connected to each of sidewalls 232a.

Cover 240 is mounted on protective sheet 220. Cover 240 includes a press portion 242, a flange 244, and a pair of arms 246.

Press portion 242 is a part that presses, through protective sheet 220, sample plate 210 toward plate support 236 of rack 230. Press portion 242 is formed in a flat plate shape. Press portion 242 has openings 242h through which dispensing probe 122 or punch pin 124 is inserted.

Flange 244 is connected to press portion 242. Specifically, flange 244 is shaped to extend outward in the width direction from each of the opposite ends, in the width direction, of press portion 242. One of flanges 244 has a slit S formed to allow positioning protrusion 232b to be inserted through the slit.

Each arm 246 is connected to flange 244. Arm 246 is described later herein after the description of rack receiving mechanism 140.

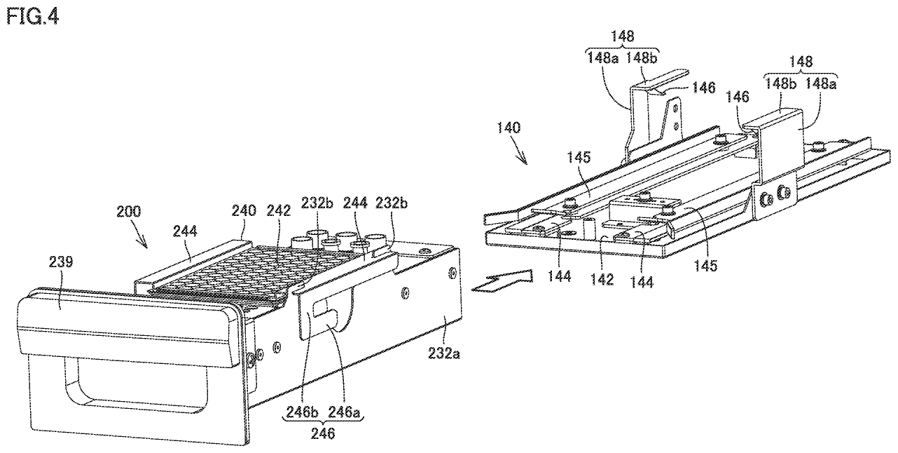

Rack receiving mechanism 140 is now described. Rack receiving mechanism 140 is a mechanism to receive rack 230. Rack receiving mechanism 140 communicates with the outside through insertion opening 110h. As shown in FIG. 4, rack receiving mechanism 140 includes a bottom plate 142, a rack holder 144, a restriction rail portion 145, an urging portion 146, and a holding arm 148.

Bottom plate 142 is formed in a flat plate shape.

Rack holder 144 removably holds rack 230. Rack holder 144 is shaped to guide insertion of rack 230 into housing 110 through insertion opening 110h. Specifically, rack holder 144 is shaped to extend in the aforementioned single direction (the direction in which rack 230 is inserted) to direct guided portion 232c.

Restriction rail portion 145 restricts rack 230 so that rack 230 is not displaced in the direction away (upward) from bottom plate 142. Restriction rail portion 145 is located above rack holder 144. Restriction rail portion 145 is shaped to extend in the direction of the insertion.

Urging portion 146 urges cover 240 toward sample plate 210 while rack 230 is held by rack holder 144. Urging portion 146 is shaped to gradually approach bottom plate 142, toward the front in the direction in which rack 230 is inserted through rack holder 144. In the present embodiment, urging portion 146 is formed by a leaf spring.

Holding arm 148 holds urging portion 146 in a manner that makes urging portion 146 face bottom plate 142. Holding arm 148 includes an erect portion 148a and a holding piece 148b.

Erect portion 148a is shaped to erect from the outer end, in the width direction, of bottom plate 142. Each erect portion 148a is located at a position separated from the other erect portion in the insertion direction.

Holding piece 148b is shaped to protrude inward in the width direction from the upper end of erect portion 148a. Erect portion 148a and holding piece 148b are formed by bending a metal sheet. Urging portion 146 is connected to the lower surface (the surface facing bottom plate 142) of holding piece 148b.

Next, arms 246 are described. Each arm 246 includes an urged portion 246a and a coupling portion 246b.

Urged portion 246a is a part to be urged toward bottom plate 142 by urging portion 146. Urged portion 246a is shaped to extend in the insertion direction. Urged portion 246a is formed in a flat plate shape. Urged portion 246a is parallel to sidewall 232a.

Coupling portion 246b is a part that couples flange 244 to urged portion 246a. Coupling portion 246b is connected to the back end, in the insertion direction, of urged portion 246a. Specifically, coupling portion 246b is located to allow insertion of holding piece 148b and urging portion 146 between flange 244 and urged portion 246a.

Next, an assembly operation for assembling parts into sample unit 200 and an installation operation for installing sample unit 200 onto rack receiving mechanism 140 are described.

Assembly Operation

First, the step of bonding protective sheet 220 to sample plate 210 in which a sample is contained in each receptacle 212, and the step of attaching sample plate 210 to plate support 236 of rack 230 are carried out. These steps may be performed in any order.

Then, cover 240 is mounted on rack 230. At this time, positioning protrusion 232b is inserted in slit S of cover 240, so that the position of cover 240 relative to rack 230 is fixed.

In this way, the parts are assembled into sample unit 200.

Installation Operation

As shown in FIG. 4, sample unit 200 is inserted in rack receiving mechanism 140. Specifically, rack 230 is inserted in rack receiving mechanism 140 while guided portion 232c of rack 230 is guided by rack holder 144 of rack receiving mechanism 140. As insertion of rack 230 proceeds, urging portion 146 is caused to abut against the front end of urged portion 246a. As insertion of rack 230 is further continued, urged portion 246a pushes up urging portion 146, against an urging force applied by urging portion 146. In other words, urged portion 246a is urged toward bottom plate 142 by urging portion 146. Accordingly, press portion 242 of cover 240 is pressed toward sample plate 210.

After urged portion 246a is caused to abut against urging portion 146, further insertion of rack 230 causes the urging force of urging portion 146 to gradually increase. After this, as insertion of rack 230 is completed, installation of sample unit 200 in apparatus body 100 is completed, which enables sample analysis to be started.

As seen from the foregoing, in electrophoresis apparatus 1 of the present embodiment, cover 240 is urged toward sample plate 210 by urging portion 146 while rack 230 is held by rack holder 144, and therefore, even when an adhesive of protective sheet 220 sticks to punch pin 124, sample plate 210 is prevented from being lifted away during analysis.

Further, rack 230 which supports sample plate 210 is held removably from apparatus body 100, and therefore, rack 230 can be removed (pulled away) from rack holder 144 so as to simultaneously perform preparation of sample plate 210 to be used for the next analysis, and cleaning, for example, of separation channel 132a of microchip 132. Accordingly, the time to be taken between analyses can be shortened.

It should be construed that embodiments disclosed herein are given by way of illustration in all respects, not by way of limitation. It is intended that the scope of the present invention is defined by claims, not by the description of the embodiments above, and encompasses all modifications and variations equivalent in meaning and scope to the claims.

For example, while a leaf spring is used as urging portion 146 in the above embodiment, urging portion 146 is not limited to the leaf spring, as long as urging portion 146 is capable of urging cover 240 toward sample plate 210. For example, a magnet that attracts cover 240 toward rack 230 may be used, or a solenoid having a plunger pressing cover 240 toward rack 230 may be used, as urging portion 146.

### ASPECTS

It is appreciated by those skilled in the art that a plurality of exemplary embodiments discussed above are specific examples of the following aspect.

Item 1: An electrophoresis apparatus according to an aspect includes: a sample plate including a receptacle for containing a sample to be analyzed; a protective sheet bonded to a surface of the sample plate and covering the receptacle; a rack that supports the sample plate; a cover mounted on the protective sheet; a rack receiving mechanism that receives the rack; a punch pin that opens a hole in the protective sheet; a dispensing probe that sucks and dispenses the sample contained in the receptacle; and a chip holder that holds a microchip having a separation channel for separating the sample by electrophoresis. The rack receiving mechanism includes: a rack holder that removably holds the rack; and an urging portion that urges the cover toward the sample plate while the rack is held by the rack holder.

The electrophoresis apparatus according to Item 1 includes the rack holder that removably holds the rack supporting the sample plate, and therefore, the rack can be removed from the rack holder to simultaneously perform preparation of a sample plate to be used for the next analysis, and cleaning, for example, of the separation channel of the microchip. Accordingly, the time taken between analyses can be shortened. Further, in the electrophoresis apparatus, the urging portion urges the cover toward the sample plate while the rack is held by the rack holder, and therefore, even when an adhesive of the protective sheet sticks to the punch pin, the sample plate is prevented from being lifted away during analysis.

Item 2: The electrophoresis apparatus according to Item 2 may further include a housing accommodating the rack receiving mechanism, the punch pin, the dispensing probe, and the chip holder. In this case, preferably the housing has an insertion opening for allowing the rack to be inserted through the insertion opening, and the rack holder is shaped to guide insertion of the rack into the housing through the insertion opening.

In the electrophoresis apparatus according to Item 2, the rack is installed on the rack holder by an operation of inserting the rack from the outside of the housing through the insertion opening, along the rack holder, and the rack is removed from the rack holder by an opposite operation to the above-described operation.

Item 3: In the electrophoresis apparatus according to Item 2, the rack receiving mechanism may further include: a bottom plate that supports the rack holder; and a holding arm that holds the urging portion in a manner that makes the urging portion face the bottom plate. In this case, preferably the urging portion is shaped to gradually approach the bottom plate, toward front in an insertion direction in which the rack is inserted into the rack holder.

In the electrophoresis apparatus according to Item 3, the urging force for the cover applied by the urging portion gradually increases as insertion of the rack proceeds along the rack holder, and therefore, the cover is prevented from vibrating with respect to the rack while the urging portion urges the cover. Accordingly, a sample in the sample plate is prevented from scattering when the cover is fixed to the sample plate.

Item 4: In the electrophoresis apparatus according to any one of Items 1 to 3, the cover may include: an urged portion subjected to an urging force applied by the urging portion; and a press portion that presses, through the protective sheet, the sample plate toward the rack while the urged portion is urged by the urging portion.

Item 5: The electrophoresis apparatus according to any one of Items 1 to 4 may further include: a voltage applicator that applies a voltage to the microchip; and a controller that controls the punch pin, the dispensing probe, and the voltage applicator.

### REFERENCE SIGNS LIST

1 electrophoresis apparatus; 100 apparatus body; 110 housing; 110h insertion opening; 120 dispensing probe portion; 122 dispensing probe; 124 punch pin; 130 chip holder; 134 voltage applicator; 140 rack receiving mechanism; 142 bottom plate; 144 rack holder; 146 urging portion; 148 holding arm; 150 controller; 200 sample unit; 210 sample plate; 212 receptacle; 220 protective sheet; 230 rack; 232 rack body; 232a sidewall; 232b positioning protrusion; 232c guided portion; 236 plate support; 239 handle; 240 cover; 242 press portion; 242h opening; 244 flange; 246 arm; 246a urged portion; 246b coupling portion

1. An electrophoresis apparatus comprising:
a sample plate including a receptacle for containing a sample to be analyzed;
a protective sheet bonded to a surface of the sample plate and covering the receptacle;
a rack that supports the sample plate;
a cover mounted on the protective sheet;
a rack receiving mechanism that receives the rack;
a punch pin that opens a hole in the protective sheet;
a dispensing probe that sucks and dispenses the sample contained in the receptacle; and
a chip holder that holds a microchip having a separation channel for separating the sample by electrophoresis, wherein
the rack receiving mechanism includes:
a rack holder that removably holds the rack; and
an urging portion that urges the cover toward the sample plate while the rack is held by the rack holder.

2. The electrophoresis apparatus according to claim 1, further comprising a housing accommodating the rack receiving mechanism, the punch pin, the dispensing probe, and the chip holder, wherein
the housing has an insertion opening for allowing the rack to be inserted through the insertion opening, and
the rack holder is shaped to guide insertion of the rack into the housing through the insertion opening.

3. The electrophoresis apparatus according to claim 2, wherein the rack receiving mechanism further includes:
a bottom plate that supports the rack holder; and
a holding arm that holds the urging portion in a manner that makes the urging portion face the bottom plate, and
the urging portion is shaped to gradually approach the bottom plate, toward front in an insertion direction in which the rack is inserted into the rack holder.

4. The electrophoresis apparatus according to claim 1, wherein
the cover includes:
an urged portion subjected to an urging force applied by the urging portion; and
a press portion that presses, through the protective sheet, the sample plate toward the rack while the urged portion is urged by the urging portion.

5. The electrophoresis apparatus according to claim 1, further comprising:
a voltage applicator that applies a voltage to the microchip; and
a controller that controls the punch pin, the dispensing probe, and the voltage applicator.
